(19) United States
(12) Patent Application Publication
(10) Pub. No.: US 2005/0036865 A1
(43) Pub. Date: Feb. 17, 2005

(54) Hand truck with lift

(76) Inventor: Marc M. Matter, Chula Vista, CA (US)

Correspondence Address: BACHMAN & LAPOINTE, P.C., 900 CHAPEL STREET, SUITE 1201, NEW HAVEN, CT, 06510, US

(21) Appl. No.: 10/640,557

(22) Filed: Aug. 13, 2003

(51) Int. Cl. B62B 1/06

(52) U.S. Cl. 414/490

(57) ABSTRACT

A hand truck for transporting articles, such as cases of beverages, is disclosed. The hand truck has a frame having a plurality of wheels attached thereto and an electrically powered lift member attached to the frame. The frame includes a pair of side frame members. Each of the side frame members has a guide mechanism for maintaining the lift member in a level condition as the lift member moves up and down relative to the frame. The lift member rides on a pair of rotating screw members driven by at least one electric motor via a sprocket gear and chain drive system.

### BACKGROUND OF THE INVENTION

The present invention relates to a hand truck for removing articles from a truck and/or for transporting articles to a desired location.

A wide variety of hand trucks for transporting a wide variety of articles are known in the prior art. U.S. Pat. Nos. 6,530,740 to Kim; 6,398,477 to Fox; 6,302,414 to Berthuaume et al.; 5,885,047 to Davis et al.; 5,707,200 to Liu; 5,251,922 to Mann; and 4,034,878 to Fox; and published U.S. Patent Application No. 2001/0038786 to Kim illustrate some of these hand trucks.

These hand trucks suffer from a number of deficiencies, most notably the need of the operator to support the load when the load is being moved and/or an inability to lift a load.

Thus, there is a need for an improved hand truck for transporting a load of articles.

### SUMMARY OF THE INVENTION

Accordingly, it is an object of the present invention to provide an improved hand truck for transporting articles.

It is a further object of the present invention to provide a hand truck as above with an electrically powered lift mechanism.

The foregoing objects are attained by the hand truck of the present invention.

In accordance with the present invention, a hand truck for transporting articles, such as cases of beverages, is provided. The hand truck broadly comprises a frame having a plurality of wheels and an electrically powered lift member attached to the frame. The frame includes a pair of side frame members. Each of the side frame members is provided with means for maintaining the lift member in a level condition as the lift member moves up and down relative to the frame. The lift member preferably rides on a pair of rotating screw members driven by at least one electric motor via a sprocket gear and chain drive system.

Other details of the hand truck with lift of the present invention, as well as other objects and advantages attendant thereto, are set forth in the following detailed description and the accompanying drawings.

### BRIEF DESCRIPTION OF THE DRAWINGS

FIG. 1 is a front view of a hand truck in accordance with the present invention;

FIG. 2 is a side view of the hand truck of FIG. 1;

FIG. 3 is a rear view of the hand truck of FIG. 1;

FIG. 4A is a perspective view of the lift guide mechanism;

FIG. 4B is a sectional view taken along lines 4B-4B in FIG. 4A;

FIG. 5 is a top perspective view showing the drive arrangement for the hand truck of the present invention;

FIG. 6 is a perspective view of the hand truck of the present invention transporting a plurality of articles;

FIG. 7 illustrates an alternative drive system for the hand truck of the present invention.

### DETAILED DESCRIPTION OF THE PREFERRED EMBODIMENT(S)

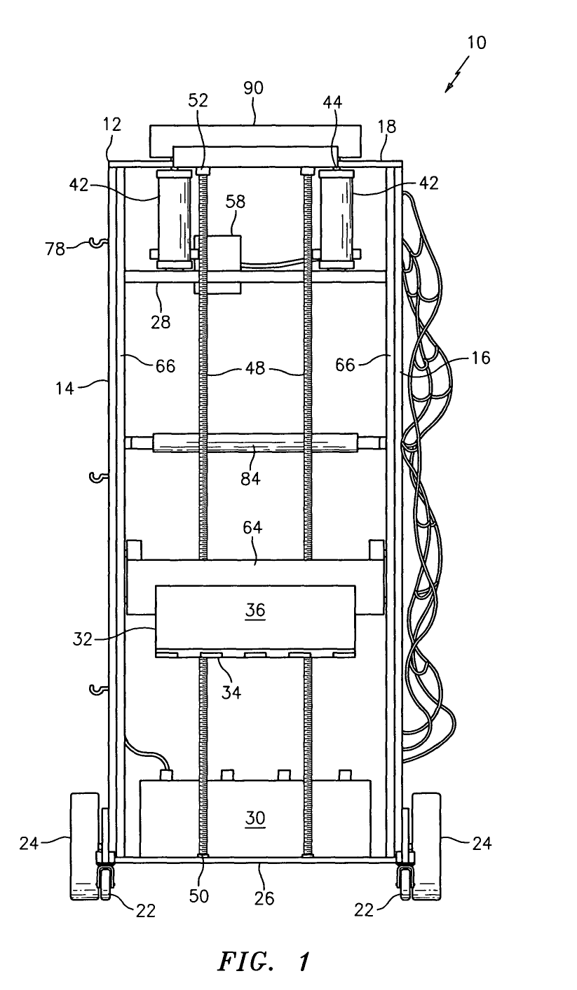

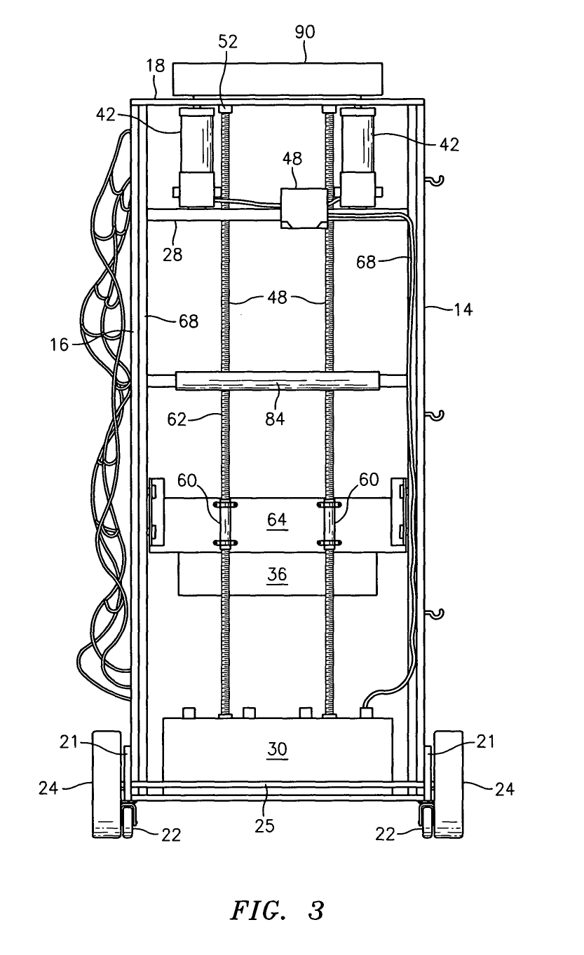

Referring now to the drawings, FIGS. 1-3 show a hand truck 10 in accordance with the present invention. The hand truck 10 has a substantially U-shaped frame 12 formed by spaced apart side frame members 14 and 16 and a top frame member 18 extending between, and joined to, the side frame members 14 and 16. The top frame member 18 may be joined to the side frame members 14 and 16 using any suitable means known in the art. For example, the top frame member 18 may be joined to the side frame members 14 and 16 by welding the members together. The frame members may be formed from any suitable material known in the art.

The frame further has a lower structural member 20 attached to each of the side frame members. Each lower structural member 20 is attached to the side frame members 14 and 16 and extends forwardly to form the front of the truck 10. A rear support member 21 is attached to the each of the lower structural members 20 and extends rearwardly to form the rear of the truck 10. The lower structural member 20 and the rear support member 21 may be formed from any suitable material known in the art

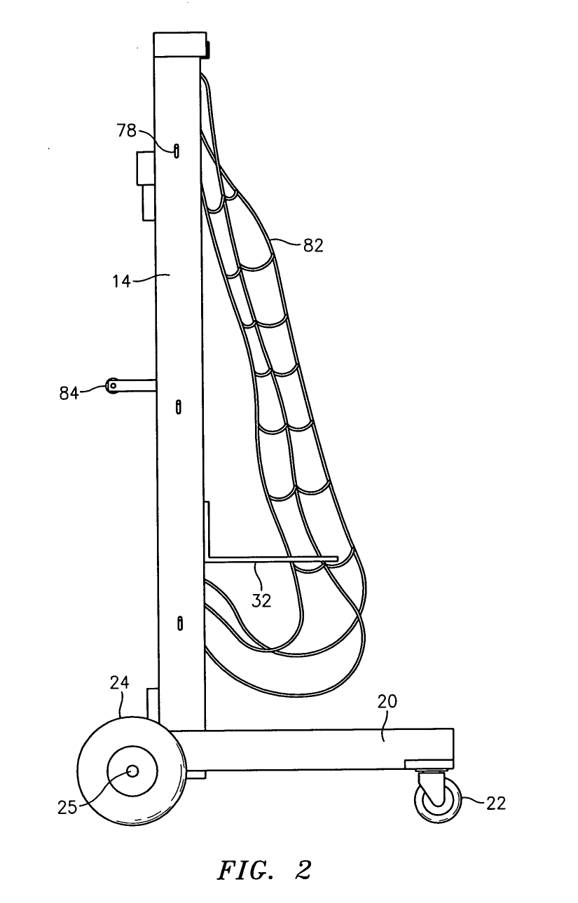

A first wheel 22 is attached to the front end of each structural member 20. The front wheel 22 may be attached to the lower structural member 20 using any suitable means known in the art which allows the wheel 22 to move relative to the structural member 20 so that the hand truck can be easily turned in a given direction. An axle 25 extends between the rear support members 21. A second wheel 24 is attached each end of the axle 25. As can be seen from FIG. 2, each first wheel 22 is smaller in diameter than each second wheel 24 so as to provide a more stable structure.

The frame 10 further has a bottom plate 26 and an intermediate support plate 28 extending between the side frame members 14 and 16. The bottom plate 26 and the intermediate support plate 28 may be joined to the side frame members 14 and 16 using any suitable means known in the art. For example, the bottom plate 26 and the intermediate support plate 28 may be joined to the side frame members 14 and 16 by welding. The bottom plate 26 and the support plate 28 may be formed from any suitable material known in the art. The bottom plate 26 may be provided with a support frame and a strap arrangement for holding a battery 30 in position.

As can be seen from FIGS. 1-3, the hand truck 10 has a lift member 32 which moves upward and downwards relative to the frame 10. The lift member 32 is formed by a first horizontal planar member 34 and an integrally formed second planar member 36 at a right angle to the first horizontal member 34. The horizontal planar member 34 may be a solid member or may have a plurality of tines 38. The tines 38, when present, may be shaped and sized to fit within one or more slots (not shown) on an article to be transported. For example, the tines 38 may be shaped and sized to fit within slots on pallets or between structural members on cases of beverages to be transported.

As shown in FIGS. 1-3, the lift member 32 is moved relative to the frame 10 by a drive system 40. The drive system 40 may comprise a pair of electric motors 42 supported on the intermediate support plate 28. Each of the electric motors 42 preferably has a shaft 44 which extends through a respective hole (not shown) in the top frame member 18. Each shaft 44 is connected to a sprocket gear 46.

The drive system 40 further has a pair of rotatable screw members 48 which extends from a lower bearing support 50 through a hole (not shown) in the top frame member 18. Upper bearing supports 52 may be provided on a lower surface of the top frame member 18 to facilitate rotation of the screw members 48. Each screw member 48 has an upper end which is connected to a sprocket gear 54.

As shown in FIG. 5, a drive transmission member 56 is provided to transfer power from the motors 42 to the rotatable screw members 48. In a preferred embodiment, the transmission member 56 comprises a continuous belt or a chain which engages the teeth of each of the sprocket gears 46 and 54.

Each of the motors 42 is preferably electrically connected to the battery 30 via a junction box 58. The electrical connection between the battery 30 and the motors 42 may include a multi-position switch (not shown) which allows the screw members 48 to rotate in a first clockwise direction when the switch is in a first position, to rotate in a second counterclockwise direction when the switch is in a second position, and to remain stationary when the switch is in a third position.

The lift member 32 travels along the rotatable screws 48 by spaced apart members 60 which are internally threaded to engage the threads 62 on the screws 48. The members 60 are mounted to a guide plate 64 which is sized to fit between the side frame members 14 and 16. The guide plate 64 may be joined to the second planar member 36 using any suitable means known in the art such as by welding or a bolt and nut arrangement.

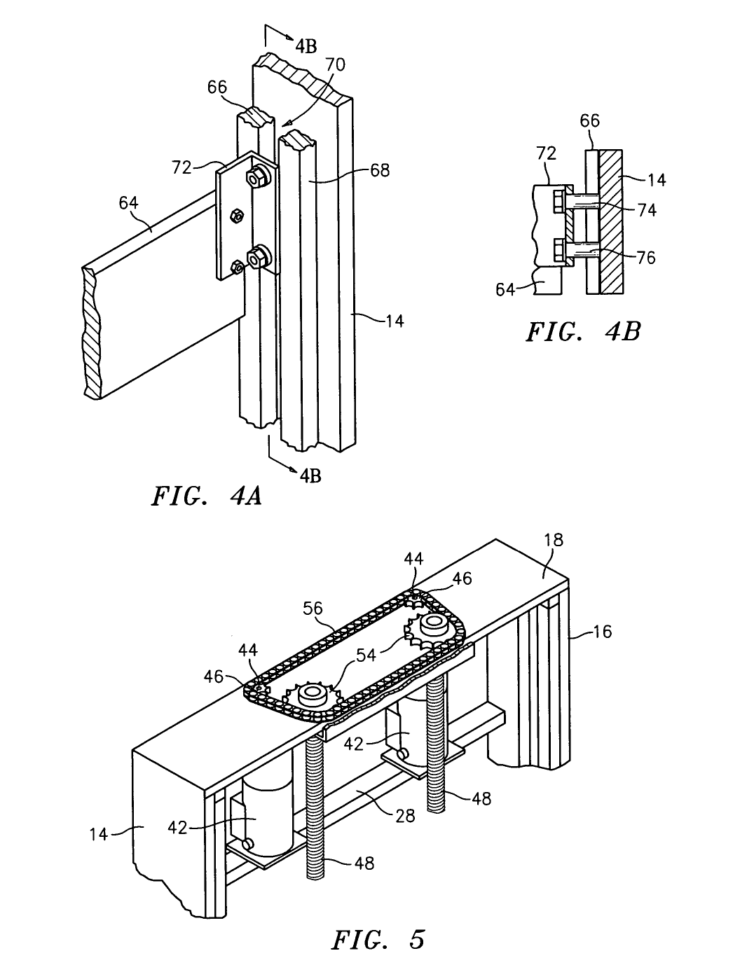

As the lift member 32 moves relative to the frame 10, it is important that the horizontal member 34 remain level. To this end, each of the side frame members 14 and 16 is provided with means for maintaining the horizontal member 34 level at all times during the operation of the lift member 32. The maintaining means, as shown in FIGS. 4A and 4B, comprises a pair of spaced guide rails 66 and 68. The guide rails 66 and 68 form a guide channel 70 which runs substantially the entire length of the side frame members 14 and 16. A pair of roller assemblies 72 are attached to the ends of the guide plate 64 such as by welding or a nut and bolt arrangement. Each of the roller assemblies 72 comprises spaced apart first and second rollers 74 and 76 which travel in the guide channel 70 mounted to a right angle bracket 75. By using two spaced apart rollers 74 and 76 in each roller assembly 72, the lift member 32, and in particular, the horizontal member 34 may be maintained level at all times during operation of the lift member 32.

To prevent articles being transported by the hand truck 10 from falling off the lift member 32 when stacked, each side frame member 14 and 16 is provided with a plurality of engaging members 78 on an outer surface 80. In a preferred embodiment, the engaging members 78 are a plurality of spaced apart hooks joined to the side frame members 14 and 16. While it is preferred to use hooks, any suitable engaging means known in the art may be used. A net 82 may be joined to a first set of the engaging members 78, either permanently or non-permanently, on one of the side frame members 14 and 16. After a plurality of articles to be transported are stacked on the lift member 32, the net 82 may be moved in front of the articles being transported and secured to the engaging members 78 on the opposite one of the side frame members 14 and 16. As a result of the presence of the side frame members 14 and 16 and the net 82 being in a taut condition, the articles being transported are safely secured on the lift member 32 so they can not fall.

To facilitate movement of the hand truck 10, a handle 84 may be joined to the side frame members 14 and 16. The handle may be joined using any suitable means known in the art. For example, the handle 84 may be bolted or welded to the side frame members 14 and 16.

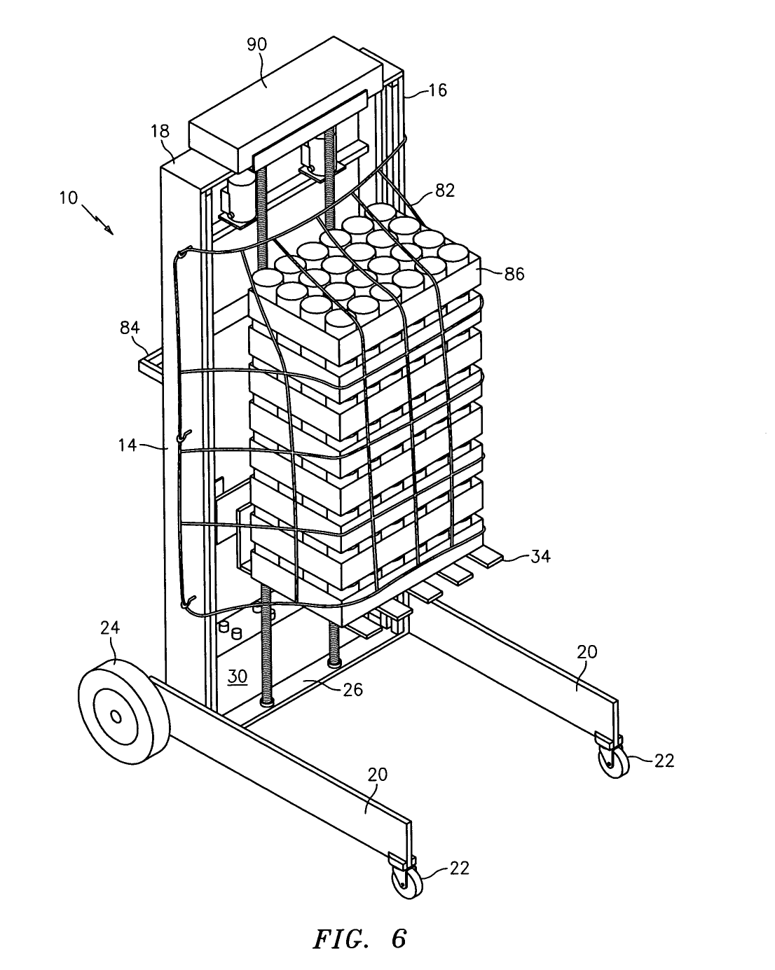

FIG. 6 shows a plurality of stacked articles 86, such as cases of one or more beverages, being transported by the hand truck 10 of the present invention. As discussed above, the net 82 may be used to hold the stacked articles 86 in place on the lift member 32.

The frame 12 and the other components of the hand truck 10 may be formed from any lightweight, metallic or non-metallic material having a desired set of strength properties.

If desired, a cover 90 may be provided over the sprocket gears 46 and 54 and the transmission means 56. The cover 90 may be formed from any suitable material and joined to the top frame member 18 using any suitable means known in the art.

While the hand truck 10 has been shown as having two electric motors 42 as part of the drive system 40, the drive system 40 may utilize only a single electric motor 42 to drive the screw members 48 if desired. When a single electric motor is used, it is preferably positioned in the center between the two side frame members 14 and 16.

While the battery 30 has been shown as being supported by the bottom plate 26, if desired, side supports (not shown) may be used to join the battery 30 to the side frame members 14 and 16.

While the rear wheels 24 have been shown as being located outside of the side frame members 14 and 16, they could be positioned internally relative to the side frame members 14 and 16 if desired.

If desired, the rear support member 21 and the lower structural member 20 may be formed into an integral structure.

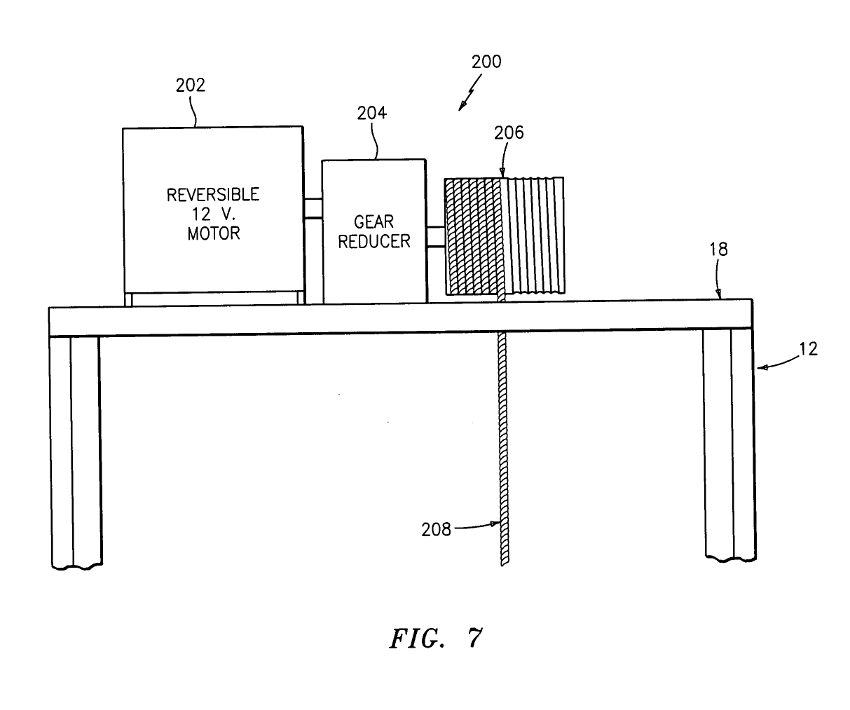

Referring now to FIG. 7, in lieu of having a drive system with two rotatable screws 48 and the electric motors 42 for driving same, the hand truck 10 may have an electrically driven cable system 200 for raising and lowering lift member 32. The cable system 200 includes a reversible 12 volt motor 202 attached to the top frame member 18, a gear reducer 204 attached to the output of motor 202 and to the top frame member 18, and a grooved cable spool 206 connected to the output of the gear reducer 204 and also mounted to the top frame member 18. The gear reducer 204 controls the output of the motor 202. A cable 208 is connected to the spool 206 and to the lift member 32. As the spool 206 is rotated in a first direction, the cable 208 comes off the spool and causes the lift member 32 to move downwards relative to the frame 12. When the spool 206 is rotated in the opposite direction, the cable 208 is wound onto the spool 206 and the lift member 32 is caused to moved upwards relative to the frame 12.

The hand truck of the present invention has particular utility in the removal of cases of beverages from a truck for transportation to a store, bar, diner, restaurant, etc.

The hand truck of the present invention is advantageous in that it is easy to use and maneuver and easy to maintain. Further, when made from lightweight materials, it is easily loaded onto, and unloaded from, a truck transporting the articles.

It is apparent that there has been provided in accordance with the present invention a hand truck with a lift which fully satisfies the objects, means, and advantages set forth hereinbefore. While the present invention has been described in the context of specific embodiments thereof, other alternatives, modifications, and variations will become apparent to those skilled in the art having read the foregoing description. Accordingly, it is intended to embrace those alternatives, modifications, and variations as fall within the broad scope of the appended claims.

1. A hand truck for transporting articles comprising:
a frame having a plurality of wheels;
an electrically powered lift member attached to said frame;
said frame including a pair of side frame members; and
each of said side frame members having means for maintaining said lift member in a level condition as said lift member moves up and down.

2. A hand truck according to claim 1, wherein:
said lift member has a first planar member oriented horizontally and a second planar member oriented perpendicular to said first planar member; and
level condition maintaining means comprising a guide track on each of said side frame members and a roller assembly for movement in each said guide track; and
each of said roller assemblies connected to said second planar member.

3. A hand truck according to claim 2, wherein each of said roller assemblies has a pair of rollers for moving within a respective one of said guide tracks.

4. A hand truck according to claim 2, wherein each of said roller assemblies is connected to said second planar member via a right angle member and a third planar member extending between said side frame members.

5. A hand truck according to claim 1, further comprising:
a pair of electric motors for raising and lower said lift member;
a pair of rotatable screw members driven by said electric motors; and
means on said lift member for engaging said rotatable screw members.

6. A hand truck according to claim 5, wherein:
each of said screw members has a first sprocket gear attached to an upper end;
each of said electric motors has a second sprocket gear driven by a shaft extending from said motor; and
means for transmitting power from said electric motors to said screw members via said first and second sprockets.

7. A hand truck according to claim 6, wherein said transmitting means comprises a chain with a plurality of links for engaging said sprockets.

8. A hand truck according to claim 5, wherein said electric motors are supported by a support member extending between said side frame members.

9. A hand truck according to claim 5, wherein each of said rotatable screw members is supported in a bearing structure at its lower end.

10. A hand truck according to claim 1, wherein said frame has a pair of lower structural members attached to said side frame members and said plurality of wheels are attached to said lower structural members.

11. A hand truck according to claim 10, wherein each lower structural member has a pair of wheels attached thereto.

12. A hand truck according to claim 11, wherein each said pair of wheels comprises a smaller wheel attached to a front end of said lower structural member and a larger wheel attached to a rear end of said lower structural member to provide improved stability.

13. A hand truck according to claim 1, wherein said lift member has a plurality of spaced apart tines for engaging articles to be transported.

14. A hand truck according to claim 1, further comprising a handle attached to a rear portion of each of said side frame members.

15. A hand truck according to claim 1, further comprising a plurality of engaging members attached to an outer surface of each of said side frame members and a net for engaging said engaging members, said net enabling articles to be stacked on said lift member and preventing said articles from falling during transportation.

16. A hand truck according to claim 15, wherein said engaging members comprise a plurality of hooks.

17. A hand truck according to claim 1, further comprising:
a reversible electric motor mounted to said frame;
a cable spool connected to said electric motor; and
a cable connected to said cable spool and to said lift member to cause said lift member to move upwardly as said cable is wound onto said cable spool and to move downwardly as said cable is taken off said cable spool.

18. A hand truck according to claim 18, further comprising a gear reducer between said motor and said cable spool for controlling the output of said motor.

19. A hand truck for transporting articles comprising:
a U-shaped frame;
a lift member for upwards and downwards movement relative to said frame;
a pair of rotatable screw members attached to said frame;
said lift member having means for engaging said rotatable screw members so as to move upwardly and downwardly as said screw members rotate in a first direction and then in a second direction; and
at least one motor for rotating said screw members via sprocket gears and a transmission member.

20. A hand truck according to claim 19, further comprising said frame having side frame members and means, associated with said side frame members, for maintaining said lift member horizontal as said lift member moves upwardly and downwardly relative to said frame.

21. A hand truck according to claim 19, further comprises a pair of electrically driven motors for rotating said screw members.

22. A hand truck according to claim 19, wherein said lift member has a plurality of tines for engaging articles to be transported.

23. A hand truck according to claim 19, further comprising at least four wheels attached to said frame to facilitate movement of said hand truck.
